(19) United States
(12) Patent Application Publication
(10) Pub. No.: US 2026/0054692 A1
(43) Pub. Date: Feb. 26, 2026

(54) Remote Keyless Entry (RKE) System And Method for Triggering a Vehicle Function of a Vehicle by Means of a Vehicle Key In Such a System

(71) Applicant: Bayerische Motoren Werke Aktiengesellschaft, Muenchen (DE)

(72) Inventors: Christian LEMKEMEYER, Muenchen (DE); Thomas WURSTHORN, Muenchen (DE)

(21) Appl. No.: 19/301,239

(22) Filed: Aug. 15, 2025

(30) Foreign Application Priority Data
Aug. 23, 2024 (DE) 10 2024 124 205.1

(51) Int. Cl. B60R 25/24; B60R 25/01

(52) U.S. Cl. CPC B60R 25/24; B60R 25/01

(57) ABSTRACT

The present disclosure relates to an RKE system with at least one vehicle key and at least one vehicle, the vehicle key having a vehicle key control device, an operating device with operating elements for generating operating information, a communication device for communicating the operating information to the vehicle via a digital channel to trigger assigned vehicle functions, and a memory for a digital key, and the vehicle having an RKE controller which is set up to convert the operating information into vehicle information. According to forms of the invention, provision is made for the operating information to contain information about the associated operating element. Furthermore, the present disclosure relates to a method for triggering a vehicle function of a vehicle by means of a vehicle key in an RKE system.

### CROSS REFERENCE TO RELATED APPLICATION

This application claims priority under 35 U.S.C. § 119 from German Patent Application No. DE 10 2024 124 205.1, filed Aug. 23, 2024, the entire disclosure of which is herein expressly incorporated by reference.

### BACKGROUND AND SUMMARY

The invention relates to a Remote Keyless Entry (RKE) system with at least one vehicle key and at least one vehicle, the vehicle key having a vehicle key control device, an operating device with operating elements for generating operating information, a communication device for communicating the operating information to the vehicle via a digital channel to trigger assigned vehicle functions, and a memory for a digital key, and the vehicle having an RKE control device which is set up to convert the operating information into vehicle information. Furthermore, the invention relates to a method for triggering a vehicle function of a vehicle by means of a vehicle key in an RKE system.

In today's automotive industry, Remote Keyless Entry (RKE) systems are widely used to allow the driver convenient, secure access to various vehicle functions, such as, for example, locking and unlocking the vehicle by means of a vehicle key, as described above. These RKE systems have been used reliably for years. More recently, efforts are being made to make the communication between such a vehicle key and the vehicle more secure and more convenient. For this purpose, the digital key standard was initiated by the Car Connectivity Consortium (CCC) to allow communication between vehicle key and vehicle on a digital basis and in particular the associated increased security by means of digital encryption technology, such as, for example, the public-private key principle. Among other things, this standard makes provisions for communication between the vehicle key and the vehicle by means of various wireless transmission technologies, such as UWB, BLE and NFC.

In existing RKE systems, operating information which is intended to trigger particular vehicle functions, such as, for example, locking and unlocking the vehicle, is permanently assigned to the individual operating elements. This permanent assignment of the functions or commands for the vehicle to the individual operating elements constitutes a simple solution for transmitting the desired information to the vehicle. However, this makes it difficult for vehicle manufacturers to produce the respective key variant for different vehicle models or markets. Moreover, in this way it is not possible for the user of the vehicle key to be able to carry out individual configuration for the operating elements of the vehicle key.

It is an object of the invention to specify an RKE system and a method which alleviate the mentioned disadvantages for the driver or manufacturer and in particular make it easier to produce different variants of a vehicle key or allow the driver to configure the vehicle key according to their wishes.

This object is achieved by an RKE system according to independent claim 1. The RKE system according to forms of the invention comprises at least one vehicle key and at least one vehicle, the vehicle key having a vehicle key control device, an operating device with operating elements for generating operating information, a communication device for communicating the operating information to the vehicle via a digital channel to trigger assigned vehicle functions, and a memory for a digital key, and the vehicle having an RKE controller which is set up to convert the operating information into vehicle information.

According to the invention, provision is made for the operating information to contain information about the associated operating element. It is thus not information about the desired vehicle function to be triggered that is transmitted from the vehicle key to the vehicle but rather information about the associated operating element. In this way, the information transmitted from the vehicle key to the vehicle is non-specific with regard to the vehicle information to be triggered. This makes it possible to easily change the configuration of the vehicle function assigned to the respective operating element.

In some implementations of the RKE system, provision is made for the RKE control device to be set up to carry out the assignment of operating information and vehicle functions on the basis of the information about the associated operating element. For example, the manufacturer can therefore produce uniform vehicle keys for all models and markets and can carry out the assignment of operating element and vehicle function in the respective vehicle - customized according to model and/or market. In the same way, for example, the driver can carry out and/or modify the assignment of operating element and vehicle function in their vehicle as desired.

In some implementations of the RKE system, the information about the operating element comprises the type of the operating element or/and the frequentness of the actuation in a time interval of the operating element or/and the duration of the actuation of the operating element. In this way, even more complex operating functions, such as a double or triple press of an operating element, a continuous press of the operating element or/and a long press of the operating element in contrast to a short actuation of the operating element can be distinguished and assigned to different vehicle functions. The assignment of the respective vehicle functions is performed flexibly in the vehicle itself or in the vehicle access system, that is to say in the RKE platform or RKE controller.

In some implementations of the RKE system, provision can be made for it to be possible for the information to also comprise the actuation of two or more operating elements simultaneously. Even more complex functions can therefore be realized in a simple way.

Particularly preferably, the operating element is a button. However, other operating elements, such as touch elements, rotary input elements or else sensors, such as location, acceleration or/and position sensors, can also act as operating elements.

In some implementations, provision is therefore in particular made for the operating information to comprise no direct information about the associated vehicle function.

In some implementations of the RKE system, the RKE controller has an assignment table which allows the operating information to be assigned to the associated vehicle function. On the one hand, the table allows easy assignment of operating information and vehicle function. On the other hand, the assignment table can be advantageous when delivering a vehicle or when changing the configuration at a later date.

The object is also achieved by a method according to the independent method claim. The method for triggering a vehicle function of a vehicle by means of a vehicle key in an RKE system has the steps of: transmitting - from the vehicle key to the vehicle - operating information of an operating element when the latter is actuated - that is to say as or immediately after the operating element is actuated; assigning the operating information to a vehicle function. In this way, it is also possible for the above-mentioned advantages of the RKE system to be realized within the scope of a method.

In some implementations of the method, the operating information comprises information relating to the type of the actuated operating element or/and the frequentness of the actuation of the operating element in a time interval or/and the duration of the actuation of the operating element.

In some implementations of the method, the transmission of the operating information comprises authentication of the vehicle key at the vehicle.

The invention will now be explained in more detail on the basis of specific embodiments with reference to the figures.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic illustration of one embodiment of an RKE system;

FIG. 2 shows a schematized functional illustration of the RKE system of FIG. 1;

FIG. 3 shows a schematized flow diagram of one embodiment of a method for triggering a vehicle function; and

FIG. 4 shows a second embodiment of a method, likewise in a schematized flow diagram.

### DETAILED DESCRIPTION OF THE DRAWINGS

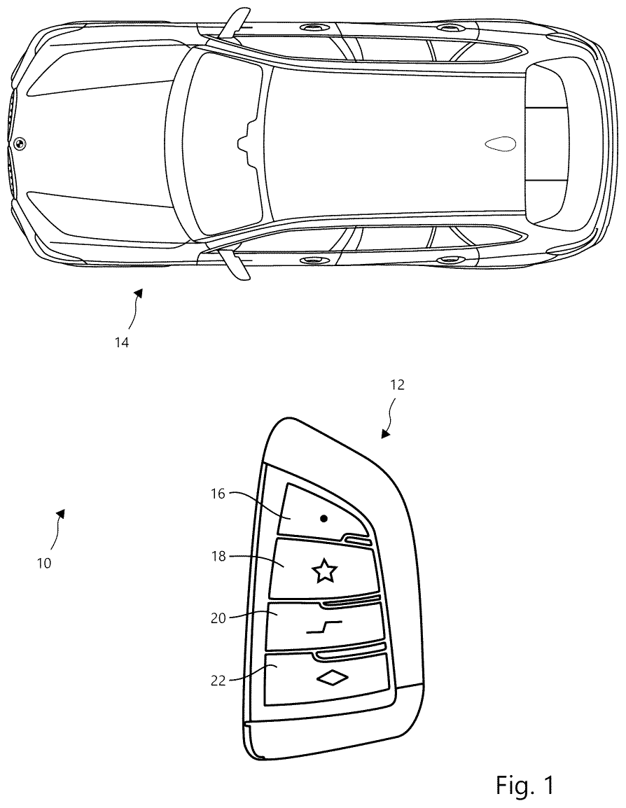

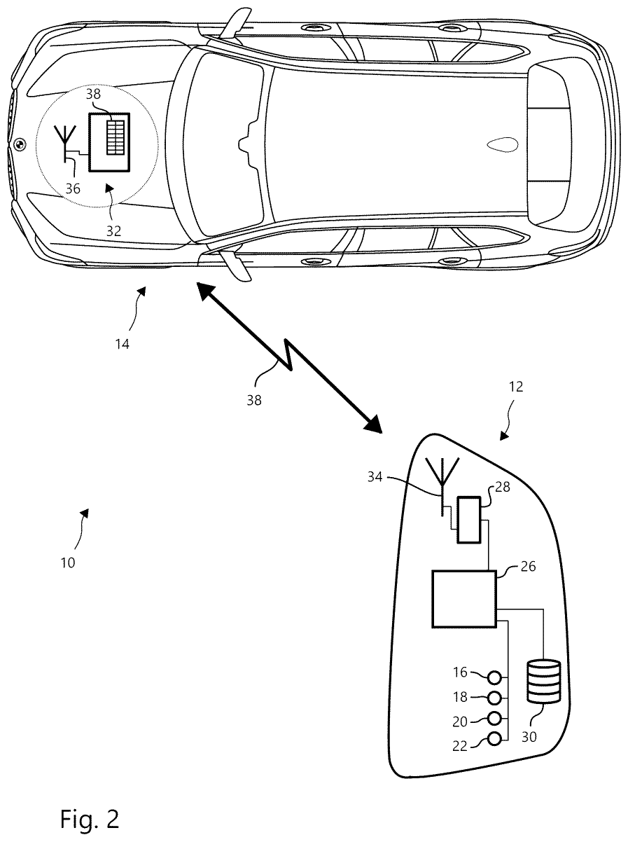

FIGS. 1 and 2 illustrate a Remote Keyless Entry (RKE) system 10 in a greatly simplified schematized illustration. In the embodiment shown, the RKE 10 comprises a vehicle key 12 and a vehicle 14. Usually, at least two or more vehicle keys 12 are assigned to a vehicle 14.. The RKE system is based on the digital key standard of the Car Connectivity Consortium (CCC) and thus provides for digital communication using cryptographic keys.

The vehicle key 12 accordingly communicates with the vehicle 14 via one or more of the communication technologies mentioned below: NFC, BLE and UWB.

As illustrated in FIG. 1, the vehicle key has a series of operating elements 16-22 which are part of an operating device 24 of the key. The operating device 24 is set up to generate operating information. This operating information comprises which operating element 16-22 was pressed, how often or for how long. As illustrated in detail in FIG. 2, the vehicle key 12 comprises a vehicle key control device 26, a communication device 28 for communicating the operating information to the vehicle 14 via a digital channel, and a memory 30. The memory 30 is used, for example, to store digital keys (not shown) which are required for encrypting/decrypting the communication between vehicle key 12 and vehicle 14.

The vehicle 14 has an RKE control device 32 which is set up to communicate with the communication device 28. In FIG. 2, this is symbolically symbolized by the antennas 34, 36 of the communication device 28 and of the RKE control device and by the double-headed arrow 38. The double-headed arrow 38 represents the wireless communication connection between vehicle key 12 and vehicle 14 via a digital channel. In addition to the ability to communicate with the vehicle key 12, the RKE control device 32 is set up to convert operating information transmitted by the vehicle key 12 into vehicle functions.

For this purpose, provision is made for the operating information sent from the vehicle key 12 to the vehicle 14 to comprise information about the actuated operating element. In order to assign the operating information to the associated vehicle function, the RKE control device 32 has, for example, an assignment table 38; however, the assignment can also be resolved via another technique.

In the embodiment of FIGS. 1 and 2, the operating elements 16-22 of the vehicle key 12 are embodied, by way of example, as buttons. The vehicle key control device 26 is designed to determine which operating element 16-22 has been actuated in the event of the actuation, whether it has been actuated once, twice or more frequently in a particular time interval or is being pressed continuously. If one of the operating elements 16-22 is pressed for a relatively long time, the control device 26 can detect the duration of the actuation. This information is communicated to the vehicle 14, or rather to the RKE control device 32, via the communication device 28. There, the operating information is assigned to the associated vehicle functions, for example on the basis of the assignment table 38, and the corresponding vehicle function is triggered. Examples of such vehicle functions can comprise one or more of the functions listed below: locking/unlocking of one/all doors; opening/closing of one, multiple or all windows; opening/closing of the tailgate; opening/locking of the front hood; establishing of the refueling readiness; starting/switching-off of the stationary air conditioning, etc.

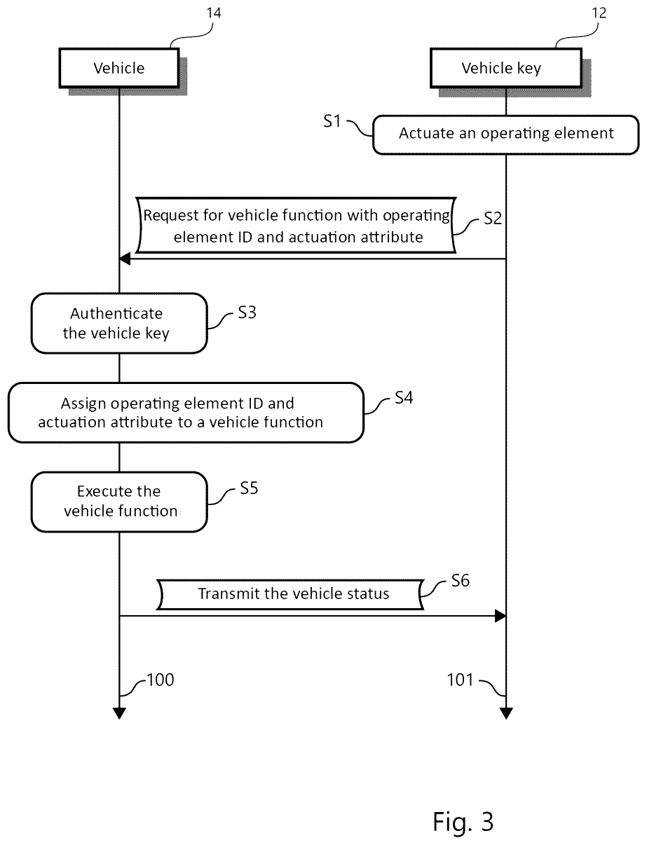

FIG. 3 illustrates a method for triggering a vehicle function of a vehicle by means of a vehicle key in an RKE system as described above. The illustration of FIG. 3 represents the chronological sequence of such a method. The diagram of FIG. 3 comprises two synchronous time lines 100, 101. A first time line 100 is assigned to the vehicle; a second time line 101 is assigned to the vehicle key.

The method begins with a user, in a step S1, actuating the vehicle key, or rather an operating element of the vehicle key. The actuation of an operating element triggers communication between the vehicle key and the vehicle. This communication is illustrated as step S2 and comprises a request from the vehicle key for a vehicle function, with only the operating element ID and an actuation attribute being sent. In other words, the only things transmitted are thus which operating element has been actuated and for how long or how often the actuation has taken place.

This communication from the vehicle key to the vehicle triggers an authentication step S3. This is only illustrated as a summary here and does not comprise all communications taking place in this case between the vehicle and the vehicle key. In short, the request in step S2 requires authentication of the vehicle key at the vehicle, which results in the exchange of encryption information for authentication.

If this authentication of the vehicle key is successful, the operating element ID and the associated actuation attribute are assigned to a vehicle function in a step S4.

The assigned vehicle function is then executed in a step S5. After the vehicle function has been completed, the new vehicle status with regard to the vehicle function is transmitted to the vehicle key in a step S6. The method ends here.

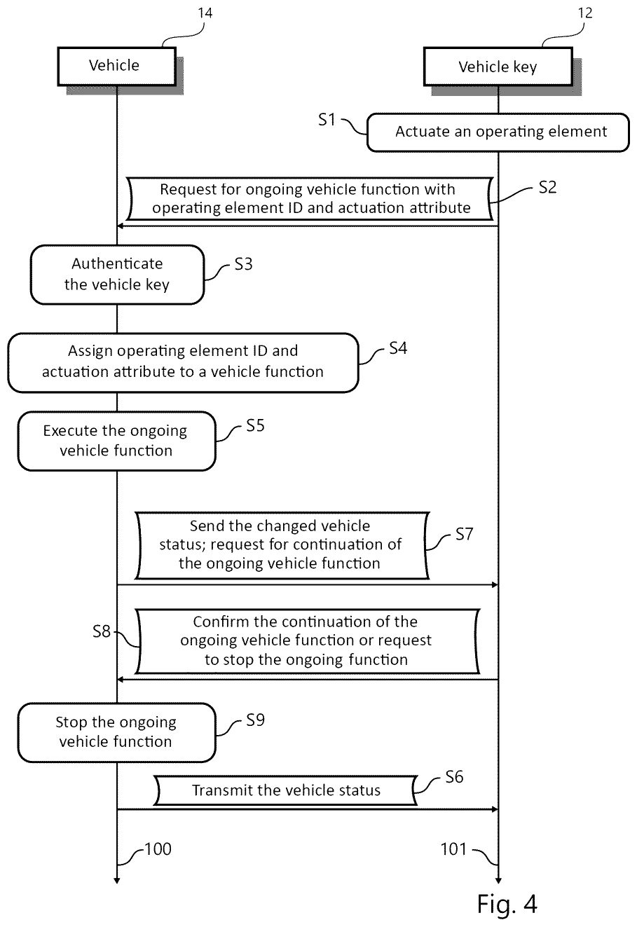

FIG. 4 likewise illustrates, analogous to the embodiment of FIG. 3, a method for triggering a vehicle function of a vehicle by means of a vehicle key in an RKE system, with the method of FIG. 4 representing the case of an ongoing vehicle function. The same or comparable method steps are provided with the same reference signs and are not explained separately again.

After the user has actuated an operating element of the vehicle key (S1), a corresponding request for this (now ongoing) vehicle function has been sent to the vehicle 14 (S2) and the key has been successfully authenticated at the vehicle (S3) and the operating element ID and the associated actuation attribute have been assigned to an ongoing vehicle function, this longer-lasting vehicle function is executed (S5).

With regard to vehicle functions which are to be executed continuously or during a particular period of time, various confirmation mechanisms can be realized by the user of the vehicle key 12. FIG. 4 illustrates the case in which the continued execution of the longer-lasting vehicle function requires constant confirmation by the vehicle key.

Accordingly, in a step S7, the changed vehicle status is initially transmitted to the vehicle key 12. This vehicle status accordingly provides for the longer-lasting vehicle function to take place. At the same time or in a separate communication, the vehicle key 12 is asked whether the ongoing vehicle function is to be continued.

The vehicle 12 accordingly waits for confirmation of the continuation of the vehicle function by the vehicle key 12. This confirmation is illustrated in the illustration of FIG. 4 as step S8. This can include either the confirmation of the continuation of the ongoing vehicle function or the request to stop the ongoing function. In the former case, step S7 is repeated—if necessary after a waiting time, for example of between 30 ms and 100 ms. In the latter case, the ongoing vehicle function is stopped with step S9. The vehicle status is subsequently transmitted to the vehicle key 12 in accordance with step S6. This ends the method.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A Remote Keyless Entry (RKE) system, comprising:
at least one vehicle key and at least one vehicle;
wherein the vehicle key comprises:
a vehicle key control device;
an operating device comprising operating elements configured to generate operating information;
a communication device configured to communicate the operating information to the vehicle to trigger assigned vehicle functions;
a memory configured to store a digital key;
wherein the vehicle comprises an RKE control device configured to convert the operating information into vehicle functions; and
wherein the operating information comprises information about the associated operating element.

2. The RKE system according to claim 1, wherein the RKE control device is configured to carry out the assignment of operating information and vehicle function on the basis of the information about the associated operating element.

3. The RKE system according to claim 1, wherein the information about the operating element comprises at least one of the type of the operating element, the frequentness of the actuation in a time interval, or the duration of the actuation.

4. The RKE system according to claim 3, where the type of the operating element further comprises the actuation of two or more operating elements simultaneously.

5. The RKE system according to claim 1, wherein the operating element is a button.

6. The RKE system according to claim 1, wherein the operating information comprises no direct information about the associated vehicle function.

7. The RKE system according to claim 1, the RKE control device having an assignment table configured to allow the operating information to be assigned to the associated vehicle function.

8. A method for triggering a vehicle function of a vehicle utilizing a vehicle key in an RKE system, the method comprising:
transmitting, from the vehicle key to the vehicle, operating information of an operating element when the latter is actuated; and
assigning the operating information to vehicle information.

9. The method according to claim 8, wherein the operating information comprises information relating to at least one of the type of the actuated operating element, the frequentness of the actuation in a time interval, or the duration of the actuation of the operating element.

10. The method according to claim 8, wherein the transmission of the operating information comprises authentication of the vehicle key by the vehicle.
